(19) United States
(12) Patent Application Publication
(10) Pub. No.: US 2006/0219453 A1
(43) Pub. Date: Oct. 5, 2006

(54) Adjustable footrest for a light vehicle

(76) Inventor: Yeong-Chen Chen, Taoyuan City (TW)

Correspondence Address: LADAS & PARRY, 26 WEST 61ST STREET, NEW YORK, NY, 10023, US

(21) Appl. No.: 11/198,627

(22) Filed: Aug. 5, 2005

(30) Foreign Application Priority Data
Apr. 4, 2005 (TW) 094205189

(51) Int. Cl. B62D 25/20

(52) U.S. Cl. 180/90.6

(57) ABSTRACT

An adjustable footrest device of a light vehicle is disclosed. The footrest is comprised of a base, which has a top, a front portion and a rear portion, in which the front portion and the rear portion substantially define the length of the footrest device. The device is further comprised of a pad that is disposed on the top of the base. The pad is adapted to pivotally move from a first position to a second position, in order to extend the length of the footrest device.

### CROSS-REFERENCES TO RELATED APPLICATIONS

Not Applicable

### Statement Regarding Federally Sponsored Research or Development

Not Applicable

### BACKGROUND OF THE INVENTION

1. Field of the Invention

The present invention relates to a footrest device for use with a light vehicle; specifically, an adjustable footrest device for use with an electrical bike or tricycle for an old aged or handicapped person.

2. Descriptions of the Related Art

A light-duty electrical vehicle (e.g. bike or tricycle) has been well developed for transporting old aged/handicapped persons. It has a relatively compact size, and can be easily stored. This kind of vehicle is easy to control and may contribute to environmental protection.

This light-duty electrical vehicle provides a short-term transportation purpose which serves to transport a person to a desired location. It may, in many aspects, offer persons enjoyment in moving from one place to another. Therefore, to provide extendable places where the user, especially those of an old aged, injured or handicapped person who has abnormally longer legs, can put their feet comfortably during usage of the vehicle is extremely important.

A conventional light-duty electrical vehicle is always equipped with a fixed-type foot pedal at the lower portion of the vehicle to provide a place for rest for a user's feet. This kind of fixed-type footrest, in practice, cannot match the needs of the user who has the aforesaid physical problem. In the case that the conventional footrest is designed to fit all user's needs, it will consequently occupy a very large space because the dimension thereof will be too large. It is understandable that this may influence the overall look of the vehicle or make shipping inconvenient.

### SUMMARY OF THE INVENTION

The primary objective of this invention is to provide an adjustable footrest device for use with a light-duty electrical vehicle to solve the problems as mentioned above by using the following measures.

The adjustable footrest device of a light vehicle is comprised of a base, which has a top, front portion and rear portion, in which the front portion and the rear portion substantially define a length of the footrest device. The device is further comprised of a pad, disposed on the top of the base. The pad is adapted to pivotally move from a first position to a second position, in order to forwardly extend the length of the footrest device.

This technology may promote a wider scope of usage without compromising the overall appearance of the vehicle and increasing the shipping size and costs because the adjustable footrest device is presented in a flexible manner in which the footrest may extend to a desired location and dimension.

Another objective of this invention is to provide an adjustable footrest device for use with a light-duty electrical vehicle. With this footrest device, there are fewer constraints in the manufacturing process; specifically, there is more flexibility in choosing the desired shaping and angle of the footrest when extended to match the configuration of the whole vehicle, thereby enhancing the quality of the overall appearance that may stimulate consumers to purchase the product made according to the present invention.

The detailed technology and preferred embodiments implemented for the subject invention are described in the following paragraphs accompanying the appended drawings for people skilled in this field to appreciate the features of the claimed invention.

### BRIEF DESCRIPTION OF THE DRAWINGS

FIG. 1 is a perspective view showing the preferred embodiment of the claimed footrest device assembled to a light vehicle with the adjustable pad at its original first position;

FIG. 2 is a partial enlarged view showing an assembly of the pad pivoting on the base of the footrest device;

FIG. 3 is a partial cross-section view showing an assembly of the pad pivoting on the base of the footrest device;

FIG. 4 is a partial section view showing the relation between the rotating post and the sleeve when the pad is in its original first position;

FIG. 5 is a partial section view showing the relation between the rotating post and the sleeve when the pad is in its extended second position; and

FIG. 6 is a perspective view showing the preferred embodiment of the claimed footrest device assembled to a light vehicle with the adjustable pad at its second position.

### DESCRIPTION OF THE PREFERRED EMBODIMENT

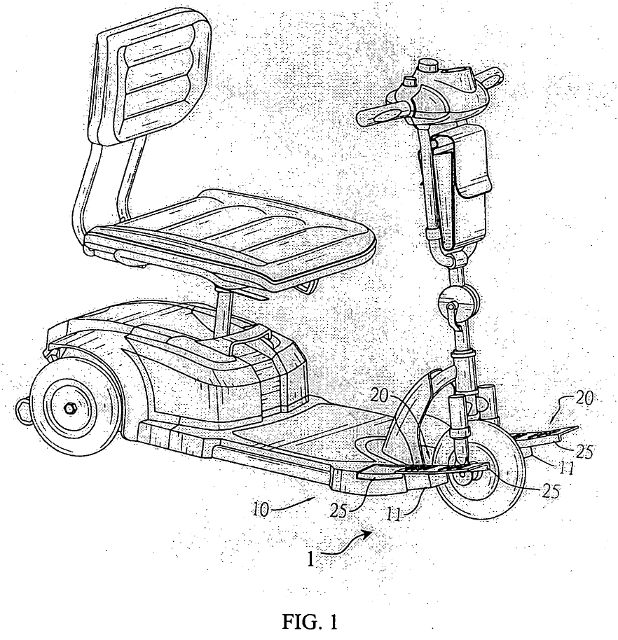

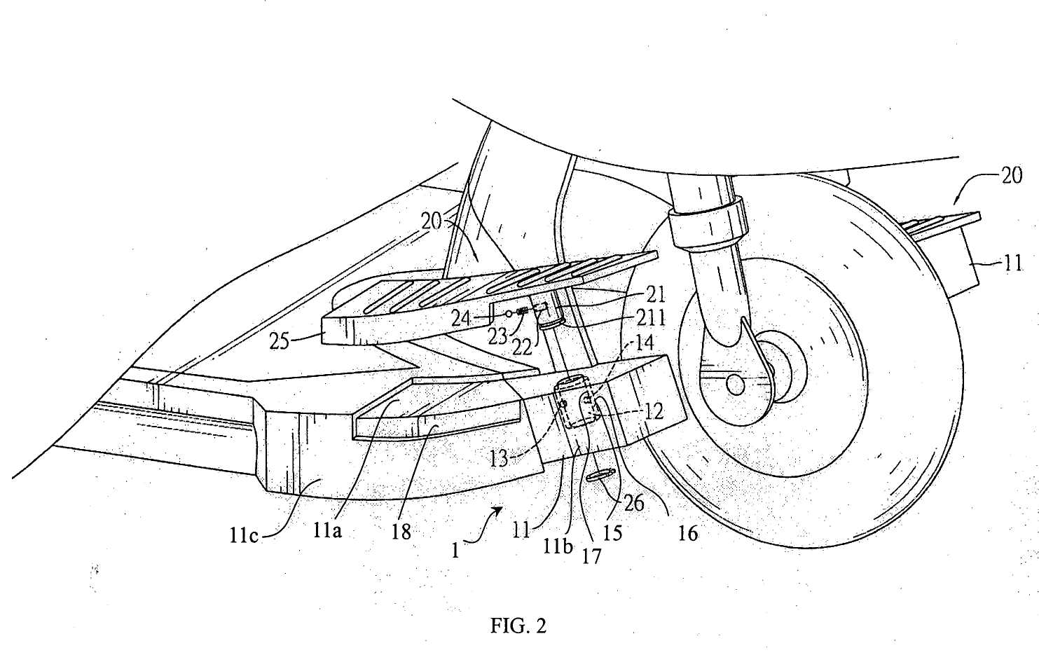

With reference to FIGS. 1 and 2, an adjustable footrest device 1 of a light vehicle 10, is comprised of a base 11 and a pad 20, in which the base has a top 11a, a front portion 11b and a rear portion 11c. The front portion 11b and the rear portion 11c substantially define the length of the footrest device 1. The pad 20 is disposed on the top 11a of the base 11.

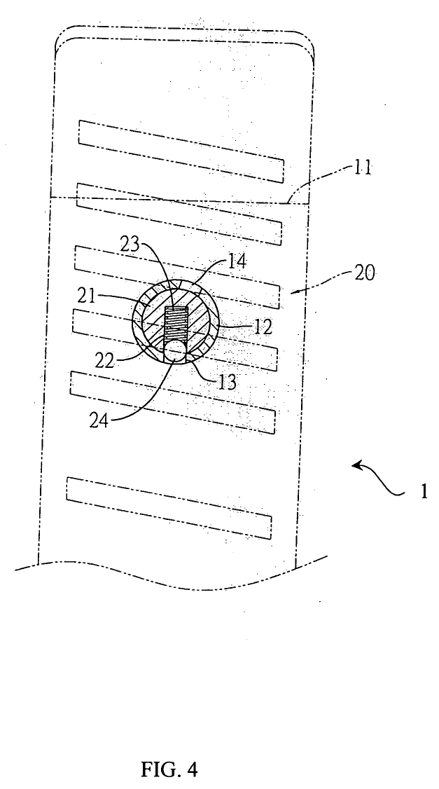

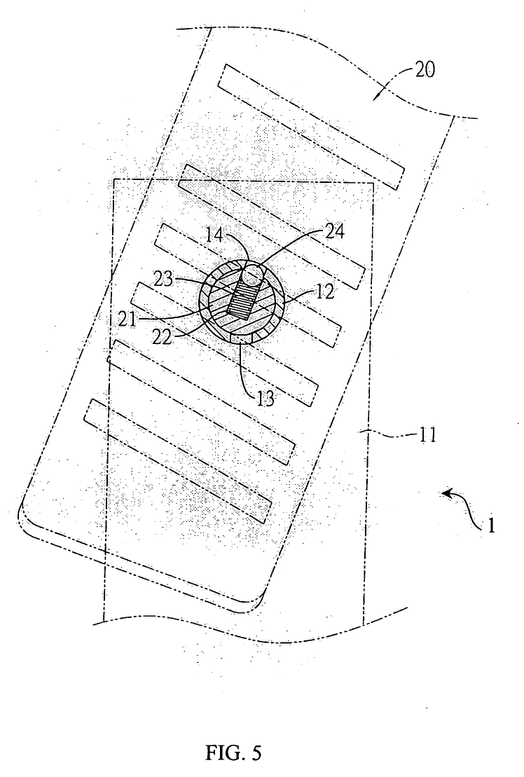

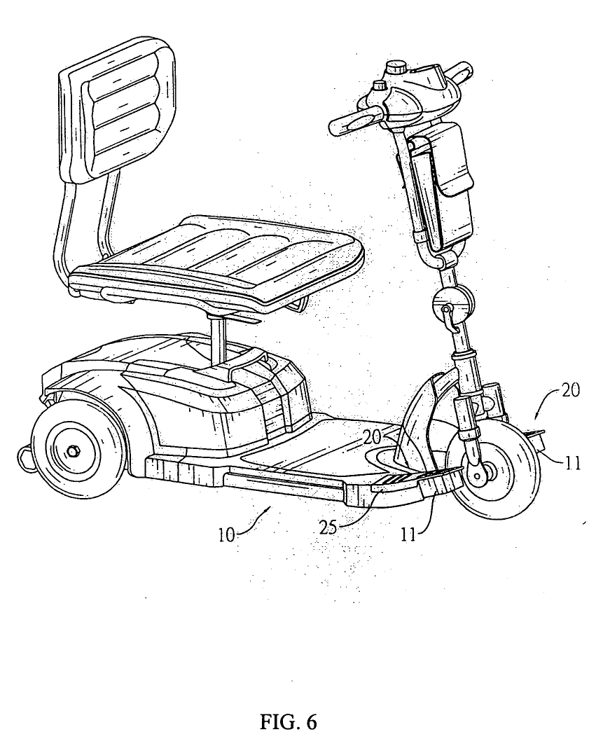

To make the device adjustably extend to create an additional footrest area, the pad is arranged to slide or pivot from a first position (see FIGS. 1 and 4) to a second position (see FIGS. 5 and 6), in order to forwardly extend the length of the footrest device 1. Preferably, by way of pivoting example, the footrest device 1 is comprised of a pivoting device disposed between the front portion 11b of the base 11 and the pad 20. The pivoting device includes a rotating post 21 extending from the bottom of the pad 20, and a hole 15 defined by a cylindrical wall 16 formed at the base 11 for receiving the rotating post 21; thereby, the pad 20 is adapted to pivot about the base 11.

The footrest device 1 is further comprised of a positioning device disposed between the base 11 and the pad 20 to draw the pad 20 so that it is stable at the aforesaid first position and second position. The positioning device includes a resilient device, a first groove 22 that is radially formed on the rotating post 21 of the pad 20, and two second grooves (not shown) formed on the cylindrical wall 16 of the hole 15 formed at the front portion 11b of the base 11, whereby each of the second grooves is adapted to fit the resilient device. The two second grooves are arranged 160 degrees apart from each other with respect to the cylindrical wall 16 of the hole 15. The resilient device preferably includes a spring 23 and a ball 24 positioned at an outer end of the spring 23. The spring 23 is fitted into the first groove 22 with the ball 24 selectively biased into each of the second grooves while the pad 20 is drawn to first position or the second position.

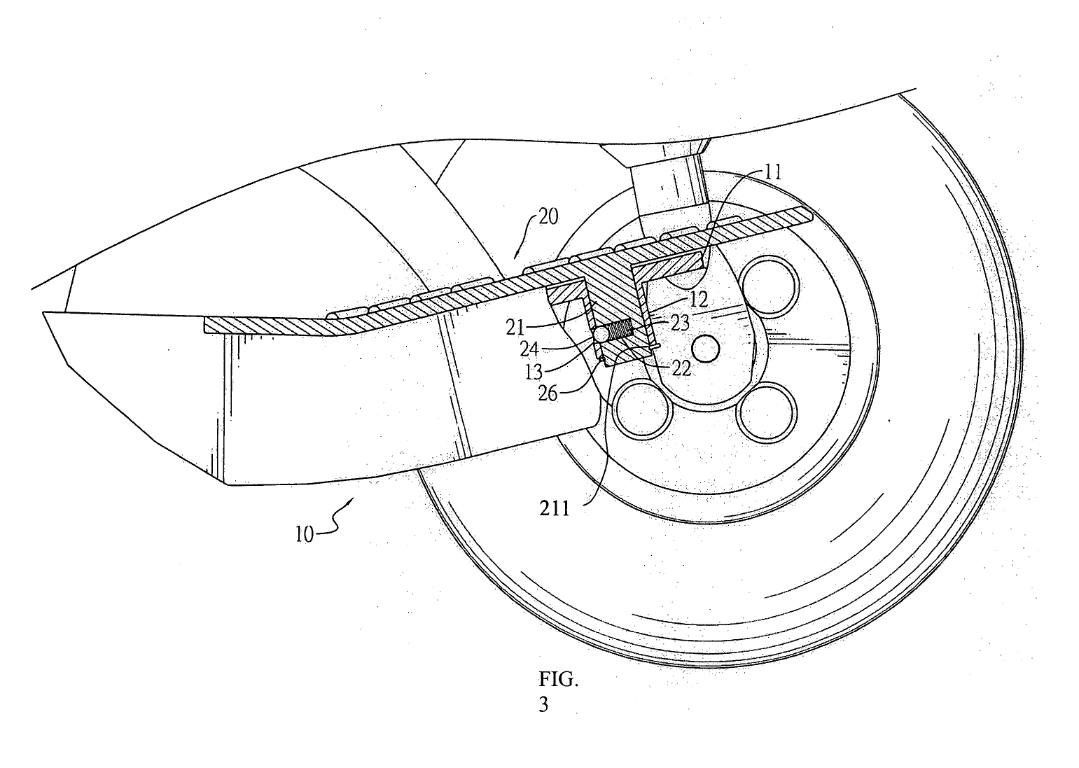

With reference to FIGS. 2 and 3, the fitting interference and manufacturing complexity caused by forming the second grooves directly at the cylindrical wall 16 of the hole 15 is reduced by having a sleeve 12 that has a cylindrical wall 17 which provides a hole for the rotating post 21 to be pivoted within the cylindrical wall 17 of the sleeve 12. In this case, third grooves 13, 14 are formed as substitutes (for the second grooves) on the cylindrical wall 17 to selectively receive the resilient device, namely, the ball 24 is biased by the spring 23 located in the first groove 22, while the pad 20 is drawn to the first position or the second position. Similarly, the two third grooves 13, 14 are preferably arranged 160 degrees apart from each other with respect to the cylindrical wall 17 of the sleeve 12, so that when the pad 20 is pivoted to its second position (see FIG. 5), it can be positioned at an ergonomically proper place to support the user's foot comfortably.

To address the issue of the base 11 being stably engaged with the pad 20, the footrest device 1 is further comprised of an engagement device for engaging the pad 20 with the base 11. Preferably, with reference to FIGS. 2 and 3, the engagement device includes an annular groove 211 formed at a lower portion of the rotating post 21, and a C-clip 26 disposed along the annular groove and slightly extending outward from an outer surface of the rotating post 21 to abut against the bottom end of the sleeve 12 when the rotating post 21 is completely assembled with the sleeve 12.

With reference to FIG. 2, over-pivoting of the pad 20 about the base 11 when the pad 20 is turned from its second position to first position is prevented by a stopper 25 that is provided on the pad 20 for this purpose. Specifically, the stopper 25 is designed as a tap downward extending from the outer edge of the pad 20. When the pad 20 is turned back to its first position where the ball 24 falls within the second groove of the hole 15 or the third groove 13 of the sleeve 12, the tap-shaped stopper 25 is adapted to resist against the edge 18 of the base 11.

The above disclosure is related to the detailed technical contents and inventive features thereof. People skilled in this field may proceed with a variety of modifications and replacements based on the disclosures and suggestions of the invention as described without departing from the characteristics thereof. By way of example only, the fitting between the pad 20 and base 11 is not necessarily like the ones as illustrated above. The rotating post can be arranged at the base 11, while the receiving hole can be adversely provided at the bottom of the pad 20. It follows that the positioning device for placing the pad at its first and second positions is disposed at the rotating post which is arranged at the base 11. In addition, the resilient device, i.e. the spring 23 and the ball 24, can be changed into a groove formed in the cylindrical wall 16 of the hole 15, while two opposing grooves can be moved to form on the rotating post 21 of the pad 11. This arrangement can achieve the same positioning function between the pad and the base 11, as set forth in the above descriptions and following drawings. Nevertheless, although such modifications and replacements are not fully disclosed in the above descriptions, they have substantially been covered in the following claims as appended.

What is claimed is:

1. An adjustable footrest device of a light vehicle, comprising:
a base, defining a length of the footrest device; and
a pad, disposed on the top of the base, the pad adapted to move from a first position to a second position, in order to extend the length of the footrest device.

2. The adjustable footrest device as claimed in claim 1, wherein the base has a top, a front portion and a rear portion, in which the front portion and the rear portion substantially define the length of the footrest device; the footrest device further comprising a pivoting device disposed between the front portion of the base and the pad.

3. The adjustable footrest device as claimed in claim 2, wherein the pivoting device includes a rotating post extending from a bottom of the pad, and a hole defined by a cylindrical wall formed at the base for receiving the rotating post, thereby the pad is adapted to pivot about the base.

4. The adjustable footrest device as claimed in claim 1, further comprising a positioning device disposed between the base and the pad to draw the pad to be at the first position and the second position.

5. The adjustable footrest device as claimed in claim 3, further comprising a positioning device disposed between the base and the pad to draw the pad to be stable at the first position and the second position.

6. The adjustable footrest device as claimed in claim 5, wherein the positioning device includes a resilient device, a first groove radially formed on the rotating post of the pad, and two second grooves formed on the cylindrical wall of the base, whereby each of the second grooves is adapted to receive the resilient device.

7. The adjustable footrest device as claimed in claim 6, wherein the resilient device includes a spring and a ball positioned at an end of the spring, thereby selectively biasing the ball into each of the second grooves while the base is drawn to each of the first position and the second position.

8. The adjustable footrest device as claimed in claim 5, further comprising a sleeve which has a cylindrical wall received in the hole to offer the rotating post to be pivoted within the cylindrical wall of the sleeve.

9. The adjustable footrest device as claimed in claim 8, wherein the positioning device includes a resilient device, a first groove radially formed on the rotating post of the pad, and two third grooves formed on the cylindrical wall of the sleeve, whereby each of the third grooves is adapted to receive the resilient device.

10. The adjustable footrest device as claimed in claim 9, wherein the resilient device includes a spring and a ball positioned at an end of the spring, thereby selectively biasing the ball into each of the third grooves while the base is drawn to each of the first position and the second position.

11. The adjustable footrest device as claimed in claim 10, further comprising an engagement device for engaging the pad with the base.

12. The adjustable footrest device as claimed in claim 11, wherein the engagement device includes an annular groove formed at a lower portion of the rotating post, and a C-clip disposed along the annular groove and slightly extending outward from an outer surface of the rotating post to abut against a bottom end of the sleeve when the rotating post is assembled with the sleeve.

13. The adjustable footrest device as claimed in claim 6, wherein the two second grooves are arranged 160 degrees apart from each other with respect to the cylindrical wall of the hole.

14. The adjustable footrest device as claimed in claim 9, wherein the two third grooves are arranged 160 degrees apart from each other with respect to the cylindrical wall of the hole.

15. The adjustable footrest device as claimed in claim 3, further comprising a stopper disposed on the pad to prevent the pad from being over-pivoting about the base when the pad is turned from the second position to the first position thereof.
